(19) United States
(12) Patent Application Publication
(10) Pub. No.: US 2021/0201431 A1
(43) Pub. Date: Jul. 1, 2021

(54) DYNAMICALLY CONTROLLED CAMERAS FOR COMPUTER VISION MONITORING

(71) Applicant: Grabango Co., Berkeley, CA (US)

(72) Inventor: William Glaser, Berkeley, CA (US)

(21) Appl. No.: 17/139,753

(22) Filed: Dec. 31, 2020

Related U.S. Application Data
(60) Provisional application No. 62/956,072, filed on Dec. 31, 2019.

(51) Int. Cl. G06T 1/00; G06T 7/73; G06T 3/40; H04N 5/232; G06T 7/11

(52) U.S. Cl. CPC G06T 1/0014; G06T 7/73; G06T 7/11; H04N 5/23206; H04N 5/23299; G06T 3/4053

(57) ABSTRACT

A system and method for dynamically controlling cameras for computer vision monitoring, which can include: operating a computer vision monitoring system with a network of imaging devices distributed across an environment; collecting, using at least a subset of imaging devices from the network of imaging devices, a first set of image data of a base image form; processing the first set of image data and generating an interpreted data model of the environment; detecting, through the data model, a data model state condition; and in response to detection of the data model state condition, capturing image data in an enhanced image data form within at least a select subregion of the environment.

### CROSS-REFERENCE TO RELATED APPLICATIONS

This application claims the benefit of U.S. Provisional Application No. 62/956,072, filed on 31 Dec. 2019, which is incorporated in its entirety by this reference.

### TECHNICAL FIELD

This invention relates generally to the field of video monitoring, and more specifically to a new and useful system and method for using dynamically controlled cameras for computer vision monitoring.

### BACKGROUND

There are many emerging applications for computer vision. In the retail space, computer vision, sometimes augmented with additional sensing systems, is being used to automate portions of retail store operations. In particular, some stores are beginning to use systems that use computer vision for tasks such as monitoring inventory, enabling automatic checkout, improving security, and other applications. In many of these cases, a camera system must be installed that has sufficient coverage of the environment. Installing high-resolution cameras with sufficient resolution and enough to cover a store can be costly. Furthermore, high-resolution images can be more costly to store and process from a computer resource standpoint. Thus, there is a need in the video monitoring field to create a new and useful system and method for using dynamically controlled cameras for computer vision monitoring. This invention provides such a new and useful system and method.

### BRIEF DESCRIPTION OF THE FIGURES

FIG. 1 is a schematic representation of a system;

FIG. 2 is a schematic representation of an exemplary multicamera unit with a dynamic actuating imaging device;

FIGS. 3-5 are schematic representations of exemplary moving imaging devices;

FIG. 6 is a flowchart representation of a method;

FIG. 7 is a flowchart representation of a method variation;

FIG. 8 is a flowchart of exemplary conditions involved in coordinating supplemental image capture;

FIG. 9 is a schematic representation of rastering a field of view of an imaging device;

FIG. 10 is a schematic representation of dynamically controlling multiple imaging devices; and

FIG. 11 is an exemplary system architecture that may be used in implementing the system and/or method.

### DESCRIPTION OF THE EMBODIMENTS

The following description of the embodiments of the invention is not intended to limit the invention to these embodiments but rather to enable a person skilled in the art to make and use this invention.

### 1. Overview

A system and method for using dynamically controlled cameras for computer vision monitoring function to use a subset of controllable cameras to augment the imaging and computer vision analysis of an environment. In particular, the system and method employ the use of dynamic imaging devices that are capable of being physically directed in different directions using an actuation system, optically zooming and/or focusing, and/or digitally controlling image collection and/or processing processes. The dynamic imaging devices of the system and method can make up a subset of the set of imaging devices used in the environment. In many cases, the dynamic imaging devices make up a minority subset of the set of imaging devices. In other situations, a full set or majority of imaging devices used in an environment may be dynamic imaging devices. In yet other variations, dynamic imaging can be a mode of operation of all or a subset of the imaging devices used in the environment.

In variations of the system and method, the dynamically controlled cameras can be used to periodically collect high value (HV) image data of key targets in an environment and/or during key events happening in the environment (e.g., zoomed images at the time a product is picked up from the shelf). HV image data may include high resolution, high definition, or high fidelity image data where the image data provides greater feature resolution over base image data. More specifically, the resolution, definition, and fidelity of the image data may be relative to one or more objects or regions of interest.

HV image data may additionally or alternatively include image data collected from different, complementary, and/or otherwise useful perspectives. For example, it at times can be useful to obtain image data from multiple perspectives for CV analysis of varying aspects. For example, image data from one camera with a straight-on view of an aisle may provide value in determining the section of an aisle a user is in proximity to but lower value image data for how a user interacts with a product as that view may be occluded. In this example, an off-angle perspective that may be captured by a controlled camera further down the aisle that rotates to view that region of the aisle at an off-axis angle may provide high value image data of a user interacting with products on the shelf.

The system and method preferably make use of a primary set of imaging devices that collect image data for processing that can be augmented and enhanced when combined with a supplemental set of imaging devices that can be operated in a coordinated manner.

The primary set of imaging devices preferably establishes a substantially uniform coverage of image capture capabilities across an environment to establish a base imaging layer. The base imaging layer additionally preferably provides substantially regular imaging data during use. In that, image data may be collected substantially continually (although in some variations image data collection may be less frequent or halted when for example there is no activity).

The supplemental set of imaging devices, which can be comprised of the set of digitally controlled cameras, may establish more dispersed coverage, where imaging devices may be positioned in key locations and/or or may have variable coverage in different regions. The supplemental set of imaging devices can collect image data selectively and responsive to conditions. In this way, the image data collected by the supplemental set of imaging devices is not continuous. Furthermore, the supplemental image data collected may be coordinated across cameras and depending on the conditions of the environment, as there may at times not limited number dynamically controlled cameras for use.

In an alternative variation, of the system and method, a set of imaging devices may be operated in normal imaging mode and an enhanced mode. In a similar manner to the primary set of imaging devices described above, the normal imaging mode may be used to establish a substantially uniform coverage of image capture capabilities across an environment to establish a base imaging layer. The normal imaging mode may be used as the default mode of collection across an environment. The enhanced mode can, in a similar manner to the supplemental set of imaging devices, selectively and responsive to different conditions collect image data with at least a subset of the imaging devices in an enhanced mode. For example, super resolution imaging or other image capture and/or processing techniques may be used when in the enhanced mode.

The system and method are preferably used for HV imaging and CV analysis of an environment. There are several ways in which HV image collection using a set of dynamically controlled cameras may be used.

As one aspect the dynamically controlled cameras may be operated to coordinate controlled high fidelity imaging with inactivity in an environment. For example, high resolution imaging of product shelving can be performed when humans or obstructions are not nearby to interfere with HD capture.

As another aspect, the dynamically controlled cameras may be operated to coordinate controlled high fidelity imaging with events of interest. In particular this may include performing HD capture and CV processing of the image data to support various CV analysis of events and interactions. The HD capture may be initiated preemptive to an event such as grabbing a product, during an event such as a user grabs a product, and after an event such as capturing the shelf after a product is removed. The system and method may coordinate event-based HD capture with controllable cameras across multiple possible events happening in parallel and distributed at different locations of an environment. In the automated checkout application, the system and method may facilitate dynamic controllable cameras capturing supplementary image data for CV processing of shopping events of multiple customers throughout a store.

As one preferred area of use, the system and method can be used in a retail environment. A grocery store is used as an exemplary retail environment in the examples described herein, however the system and method is not limited to retail or to grocery stores. In other examples, the system and method can be used in supermarkets, department stores, apparel stores, bookstores, hardware stores, electronics stores, gift shops, and/or other types of shopping environments. Furthermore, the system and method may be used in a wide variety of applications; in particular, the system and method may be used in any surveillance system and/or other areas where CV monitoring may be of use. The system and method may, however, provide particular benefits to use cases where particular user-item interactions are of particular value for monitoring.

In one preferred implementation, the system and method are used in combination with a monitoring system used for automated or semi-automated checkout. Herein, automated and/or semi-automated checkout is primarily characterized by a system or method that generates or maintains a virtual cart (i.e., a checkout list) during the shopping experience with the objective of tracking the possessed or selected items for billing a customer. The checkout process can occur when a customer is in the process of leaving a store. The checkout process could alternatively occur when any suitable condition for completing a checkout process is satisfied such as when a customer selects a checkout option within an application.

A virtual cart may be maintained and tracked during a shopping experience through use of one or more monitoring system. In performing an automated checkout process, the system and method can automatically charge an account of a customer for the total of a shopping cart and/or alternatively automatically present the total transaction for customer completion. Actual execution of a transaction may occur during or after the checkout process in the store. For example, a credit card may be billed after the customer leaves the store. Alternatively, single item or small batch transactions could be executed during the shopping experience. For example, automatic checkout transactions may occur for each item selection event. Checkout transactions may be processed by a checkout processing system through a stored payment mechanism, through an application, through a conventional PoS system, or in any suitable manner.

One variation of a fully automated checkout process may enable customers to select items for purchase (including produce and/or bulk goods) and then leave the store. The automated checkout system and method could automatically bill a customer for selected items in response to a customer leaving the shopping environment. The checkout list can be compiled using computer vision and/or additional monitoring systems. In a semi-automated checkout experience variation, a checkout list or virtual cart may be generated in part or whole for a customer. The act of completing a transaction may involve additional systems. For example, the virtual cart can be synchronized with (or otherwise transmitted to) a point of sale (POS) system manned by a worker so that at least a subset of items can be automatically entered into the POS system thereby alleviating manual entry of the items.

The system and method may provide a number of potential benefits. The system and method are not limited to always providing such benefits, and are presented only as exemplary representations for how the system and method may be put to use. The list of benefits is not intended to be exhaustive and other benefits may additionally or alternatively exist.

As one potential benefit, the system and method may enable a few high cost cameras to be put into use. The majority of cameras can be lower cost cameras that are suitable for providing a base layer of CV monitoring of an environment. However, the system and method can use the dynamically controlled imaging devices to operate as if covered by high resolution cameras.

As another potential benefit, the system and method may enable more efficient use of computer resources. By using lower resolution cameras for the base layer of image data there will be, in general, be lower resolution image data for basic processing and less data to be stored. This can reduce the amount of computer-power capacity, lower data bandwidth requirements, and/or lower data storage requirements. The HV image data collection can be used selectively where it can help increase confidence of the CV monitoring or at least provide supporting image data.

As another related potential benefit, the system and method can improve the accuracy and reliability of a CV monitoring system. By making it more feasible to capture more useful image data, a CV monitoring system and/or other suitable image analysis systems can become operate more accurately.

### 2. System

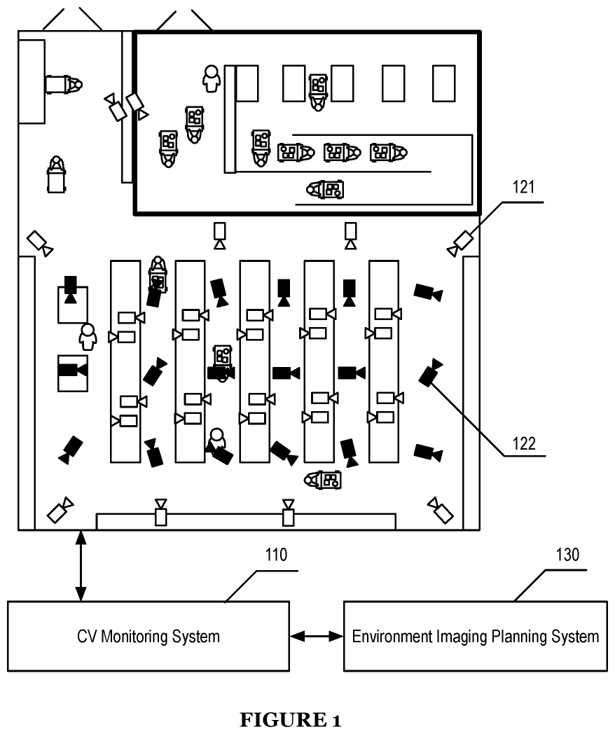

As shown in FIG. 1, a system making use of dynamically controlled cameras can include a CV monitoring system 110 that includes at least one set of imaging devices 121 configurable for collecting image data of a base image form and a second set of dynamically controlled imaging devices 122 configurable for collecting image data of an enhanced image mode, and an environment imaging planning system 130 configured to coordinate control of the set of dynamically controlled imaging devices. The first set of imaging devices and second set of imaging devices may be the same set of imaging devices or may share a subset of imaging devices (e.g., where a subset of imaging devices can collect base image data and enhanced image data). Alternatively, the first set of imaging devices and the second set of imaging devices may be distinct.

The environment that hosts the system and described herein is preferably one with some item and/or activity that is monitored. In some preferred applications, the environment may be one with a set of items intended for identification and tracking in relationship to some interaction, possibly interactions with users (e.g., customers using automated checkout).

Herein, reference to items preferably characterizes items intended for at least one form of identification. In a retail environment, the items may alternatively be referred to as products, where identification may refer to identification of an item-associated product identifier like a stock-unit identifier (SKU identifier), a universal product code (UPC), or any suitable type of product record. The environment will generally also include other types of physical objects such as people, environment infrastructure (e.g., shelves, lights, signage, etc.), and other types of objects.

Preferably, at least a subset of the items is identifiable and integrated for CV-based monitoring through an item detection module. In some instances, the system may assist in the identification.

A CV monitoring system 110 of a preferred embodiment functions to transform image data collected within the environment into observations relating in some way to items in the environment. Preferably, the CV monitoring system no is used for detecting items, monitoring users, tracking user-item interactions, and/or making other conclusions based on image and/or sensor data. The CV monitoring system no will preferably include various computing elements used in processing image data collected by an imaging system. In particular, the CV monitoring system no will preferably include an imaging system and a set of modeling processes and/or other processes to facilitate analysis of user actions, item state, and/or other properties of the environment.

The CV monitoring system no is preferably configured to facilitate identifying of items, the locations of items relative to various shelf-space locations, and/or detection of interactions associated with identified items.

The CV monitoring system 110 preferably provides specific functionality that may be varied and customized for a variety of applications. In addition to item identification, the CV monitoring system no may additionally facilitate operations related to person identification, virtual cart generation, item interaction tracking, store mapping, and/or other CV-based observations. Preferably, the CV monitoring system 110 can at least partially provide: person detection; person identification; person tracking; object detection; object classification; object tracking; gesture, event, or interaction detection; detection of a set of customer-item interactions, and/or other forms of information.

In one preferred embodiment, the system can use a CV monitoring system 110 and processing system such as the one described in US Patent Publication No. 2017/0323376, filed on May 9, 2017, which is hereby incorporated in its entirety by this reference. The CV monitoring system no will preferably include various computing elements used in processing image data collected by an imaging system.

The imaging system functions to collect image data within the environment. The imaging system preferably includes a set of imaging devices and a set of dynamically controlled imaging devices. The set of imaging devices may be referred more specifically as a set of base imaging devices. The set of base imaging devices preferably provide image data that is collected as a standard layer of image data for monitoring the environment. The imaging devices of the base imaging devices may also have various control features and in some cases the imaging system may have a set of imaging devices wherein each imaging devices may be selectively used in different modes. As a default base mode, the imaging devices operate in a base mode providing image data of a defined region. However, under particular conditions, an imaging device may be operated as dynamically controlled imaging device where it used to capture various forms HV image data.

The imaging system might collect some combination of visual, infrared, depth-based, lidar, radar, sonar, and/or other types of image data. The imaging system is preferably positioned at a range of distinct vantage points. However, in one variation, the imaging system may include only a single image capture device. In one example, a small environment may only require a single camera to monitor a shelf of purchasable items. The image data is preferably video but can alternatively be a set of periodic static images. In one implementation, the imaging system may collect image data from existing surveillance or video systems. The image capture devices may be permanently situated in fixed locations. Alternatively, some or all may be moved, panned, zoomed, or carried throughout the facility in order to acquire more varied perspective views. In one variation, a subset of imaging devices can be mobile cameras (e.g., wearable cameras or cameras of personal computing devices). For example, in one implementation, the system could operate partially or entirely using personal imaging devices worn by users in the environment (e.g., workers or customers).

The imaging system preferably includes a set of static image devices mounted with an aerial view from the ceiling or overhead. The aerial view imaging devices preferably provide image data that observes at least the users in locations where they would interact with items. Preferably, the image data includes images of the items and users (e.g., customers or workers). While the system (and method) are described herein as they would be used to perform CV as it relates to a particular item and/or user, the system and method can preferably perform such functionality in parallel across multiple users and multiple locations in the environment. Therefore, the image data may collect image data that captures multiple items with simultaneous overlapping events. The imaging system is preferably installed such that the image data covers the area of interest within the environment.

Herein, ubiquitous monitoring (or more specifically ubiquitous video monitoring) characterizes pervasive sensor monitoring across regions of interest in an environment. Ubiquitous monitoring will generally have a large coverage area that is preferably substantially continuous across the monitored portion of the environment. However, discontinuities of a region may be supported. Additionally, monitoring may monitor with a substantially uniform data resolution or at least with a resolution above a set threshold. In some variations, a CV monitoring system no may have an imaging system with only partial coverage within the environment.

The system preferably includes at least a subset of imaging devices 121 that function to collect image data in a base image form, which functions as imaging devices that collect image data for normal, regular operation. In one variation, the first set of imaging devices may be limited to collecting base image data. Such imaging devices may be made more limited using lower resolution image sensors, lower quality optics and being statically positioned. However, as mentioned, in some variations, imaging devices part of the second set of imaging devices used in collecting supplemental HV enhanced image data may switch between collecting base image data and enhanced image data.

The second set of dynamically controlled imaging devices 122 preferably includes imaging devices that include at least one variable and controllable property for how image data is collected and/or processed. The controlled imaging devices may be used so that detailed image data can be collected of specific target regions. These targeted regions can be changed based on the conditions. The controlled imaging devices may additionally or alternatively be used in some instances to collect image data with a wide field of view to facilitate bridging monitoring of image data collected from within that field of view.

A dynamically controlled imaging device may include a controllable actuation system (e.g., an actuating imaging device). The actuation system can function as a gimbal so that a camera can be directed at different regions. An actuation system may enable a camera with a narrow field of view to be used to collect detailed image data of particular regions of an environment. For example, an actuated controlled imaging device may be used to be actuated so as to raster over across a product storage region to collect detail product imagery.

A dynamically controlled imaging device may include an optical zoom system (e.g., an optically zoomable imaging device). The controlled optical zoom can enable image data to be collected with varying degrees of zoom. This may be used to collect zoomed high resolution image data of a particular region. The zoom may alternatively be used to collect wide field of view image data.

A dynamically controlled imaging device may include a multi-lens camera system wherein different types of camera systems can be used in various modes. For example, a controlled imaging device may include a two, three or even four camera imaging system where the different cameras each provide different capabilities that can be combined to form different types of data.

A dynamically controlled imaging device may also have various digitally controlled aspects. For example, the camera system of the dynamically controlled imaging device may have different modes it can be operated in such as a high resolution mode or a low resolution mode. It may also include video modes with varying frame rates or still image modes, which may offer high resolution. It may include rolling shutter modes or a global shutter mode. These different modes may be used to capture different forms of image data. This may involve image processing that is preferably performed prior to processing by a CV processing module. In one example, a digital control of image collection may be used to collect high resolution still image data and then to crop the image data to a select region of the image data corresponding to a target region of the environment. In another variation, an imaging device may be operated for the collection of sequences of image data that is processed for super-resolution processing, which may generate image data of image resolution greater than that of the imaging sensor by combining images of the same scene.

These various digitally controlled aspects may be combined in any suitable permutation or combined with other dynamic features.

The set of dynamically controlled imaging devices 122 may include a plurality of imaging devices that have substantially similar features like actuation, optical zoom, and the like. Alternatively, the set of dynamically controlled imaging devices 122 may be comprised of different types of dynamically controlled imaging devices. For example, a first subset of dynamic imaging devices may be actuated, a second subset of dynamic imaging devices may have optical zoom, and a third subset of dynamic imaging devices may be IR cameras with higher resolution image sensors.

The set of dynamically controlled imaging devices 122 are preferably distributed throughout the environment such that they have coverage across key regions of the environment. In one implementation, they may be distributed so that they can be providing image data across substantially the same regions as the set of base imaging devices. This coverage may not be defined by simultaneous coverage. In the case where the dynamic cameras are actuated, the coverage may be characterized as potential coverage factoring in the regions where the dynamic cameras can cover with actuation. Alternatively, the dynamically controlled imaging devices may provide coverage across a subset of regions. For example, in some portions of the environment the set of base imaging devices may be sufficient such as in regions of a retail environment where the products and user-item interactions are more easily monitored. Conversely, the dynamically controlled imaging devices may be positioned for coverage of more challenging monitoring regions such in a retail environment where products are small or are displayed in less organized manner (e.g., produce region).

As one example, within an aisle, there may be a set of dynamically controlled imaging devices positioned periodically along the aisle. There may be one on either end of the aisle and then a few distributed down the length. Between the dynamically controlled imaging devices there may be a plurality of base imaging devices that are statically fixed for more regular data collection.

In one variation, the imaging devices may be integrated into multicamera unit with a structural body that pre-arranges position of the imaging devices for regular imaging within an environment. The multicamera unit may include internal processors. The system may additionally or alternatively remotely control the operation of the multicamera units. The imaging devices can include network and/or power connections such that they can be interconnected in series. In one variation, the multicamera units can be connected in series and chained together such as in the camera devices of U.S. Pat. No. 10,778,906, issued 15 Sep. 2020, which is hereby incorporated in its entirety by this reference.

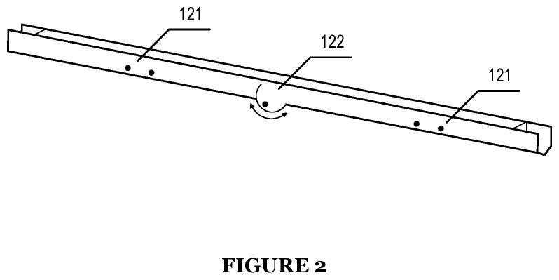

In one variation, the multicamera units can include a rail structural body. A rail structural body variation can come in different lengths. Some exemplary lengths may include lengths that are somewhere between 3-10 feet. In some instances, a set of different lengths may be used: a 2-3 foot enclosure body, a 5-6 foot enclosure body, and a 9-12 foot enclosure body. Any suitable length may alternatively be used. Within the rail structural body, there may be a subset of imaging devices that are dynamically controlled imaging devices. For example, there may be one or two actuating imaging devices with digitally controlled optically zoomable lenses as shown in FIG. 2.

In one variation, the set of dynamically controlled imaging devices may additionally include moving imaging devices. The moving imaging devices can include an automated moving system that transports the dynamic imaging devices to different locations in the environment. An imaging device(s) integrated into the moving imaging device can then capture image data. The imaging devices on the moving imaging device may have greater sensing capabilities but may alternatively be better positioned for enhanced imaging of targeted objects.

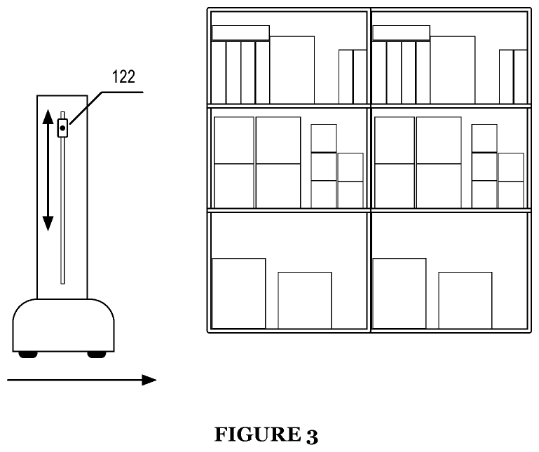

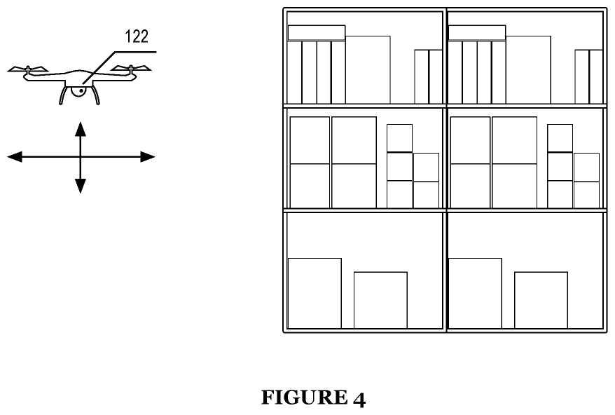

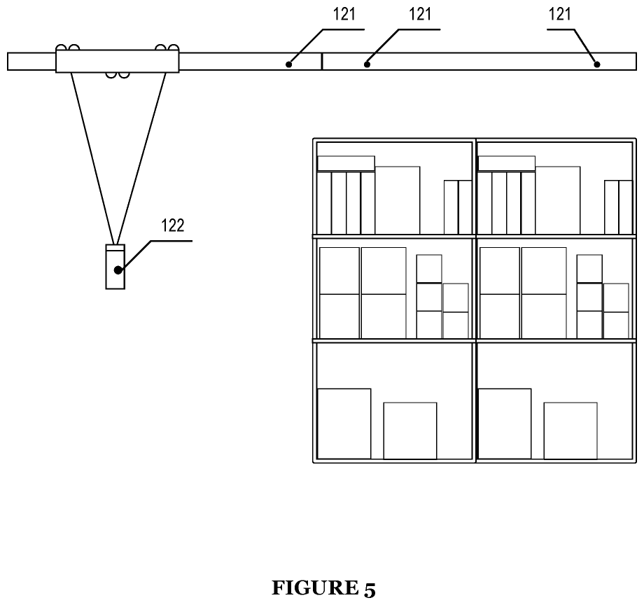

The automated moving system can include a ground-based robotic system such as a robotic system that rolls along the ground as shown in FIG. 3. The automated moving system may alternatively be an aerial flying robot such as a drone that can fly through the environment as shown in FIG. 4. The automated moving system may alternatively include a suspended camera system or a system that can move a camera along a track. In one variation, a cable-based camera gantry system may be used where a camera can be moved up and down, translated to different positions in the environment, and optionally rotated using cables or wires to suspend one or more imaging devices as shown in FIG. 5. The suspended camera system may move along a track system to move to different positions in the environment. In one variation, the track system may be integrated into the camera rails described above. Any suitable automated moving system may be used. These movable controlled imaging devices may be coordinated in a similar manner to stationary dynamically controlled imaging devices. Preferably, they are moved so as to minimize impact to users interacting in the environment though any suitable control approach may be used.

A CV-based processing engine and data pipeline preferably manages the collected image data and facilitates processing of the image data to establish various conclusions. The various CV-based processing modules are preferably used in generating user-item interaction events, a recorded history of user actions and behavior, and/or collecting other information within the environment. The data processing engine can reside local to the imaging system or capture devices and/or an environment. The data processing engine may alternatively operate remotely in part or whole in a cloud-based computing platform.

The item detection module of a preferred embodiment, functions to detect and apply an identifier to an object. The item detection module preferably performs a combination of object detection, segmentation, classification, and/or identification. This is preferably used in identifying products or items displayed in a store. Preferably, a product can be classified and associated with a product SKU identifier. In some cases, a product may be classified as a general type of product. For example, a carton of milk may be labeled as milk without specifically identifying the SKU of that particular carton of milk. An object tracking module could similarly be used to track items through the store.

In a successfully trained scenario, the item detection module properly identifies a product observed in the image data as being associated with a particular product identifier. In that case, the CV monitoring system 110 and/or other system elements can proceed with normal processing of the item information. In an unsuccessful scenario (i.e., an exception scenario), the item detection module fails to fully identify a product observed in the image data. An exception may be caused by an inability to identify an object, but could also be other scenarios such as identifying at least two potential identifiers for an item with sufficiently close accuracy, identifying an item with a confidence below a certain threshold, and/or any suitable condition whereby a remote item labeling task could be beneficial. In this case the relevant image data is preferably marked for labeling and/or transferred a product mapping tool for human assisted identification.

As described below, the item detection module may use information from detected physical labels to assist in the identification of products.

The item detection module in some variations may be integrated into a product inventory system. The product inventory system functions to detect or establish the location of inventory/products in the environment. The product inventory system can manage data relating to higher level inventory states within the environment. For example, the inventory system can manage a location/position item map, which could be in the form of a planogram. The planogram may be based partially on the detected physical labels and/or CV product classification. The inventory system can preferably be queried to collect contextual information of an unidentified item such as nearby items, historical records of items previously in that locations, and/or other information. Additionally, the inventory system can manage inventory data across multiple environments, which can be used to provide additional insights into an item. For example, the items nearby and/or adjacent to an unidentified item may be used in automatically selecting a shortened list of items used within the product mapping tool.

User-item interaction processing modules function to detect or classify scenarios of users interacting with an item (or performing some gesture interaction in general). User-item interaction processing modules may be configured to detect particular interactions through other processing modules. For example, tracking the relative position of a user and item can be used to trigger events when a user is in proximity to an item but then starts to move away. Specialized user-item interaction processing modules may classify particular interactions such as detecting item grabbing or detecting item placement in a cart. User-item interaction detection may be used as one potential trigger for an item detection module.

A person detection and/or tracking module functions to detect people and track them through the environment.

A person identification module can be a similar module that may be used to uniquely identify a person. This can use biometric identification. Alternatively, the person identification module may use Bluetooth beaconing, computing device signature detection, computing device location tracking, and/or other techniques to facilitate the identification of a person. Identifying a person preferably enable customer history, settings, and preferences to be associated with a person. A person identification module may additionally be used in detecting an associated user record or account. In the case where a user record or account is associated or otherwise linked with an application instance or a communication endpoint (e.g., a messaging username or a phone number), then the system could communicate with the user through a personal communication channel (e.g., within an app or through text messages).

A gesture, event, or interaction detection modules function to detect various scenarios involving a customer. One preferred type of interaction detection could be a customer attention tracking module that functions to detect and interpret customer attention. This is preferably used to detect if, and optionally where, a customer directs attention. This can be used to detect if a customer glanced in the direction of an item or even if the item was specifically viewed. A location property that identifies a focus, point, or region of the interaction may be associated with a gesture or interaction. The location property is preferably 3D or shelf location “receiving” the interaction. An environment location property on the other hand may identify the position in the environment where a user or agent performed the gesture or interaction.

Alternative forms of CV-based processing modules may additionally be used such as customer sentiment analysis, clothing analysis, customer grouping detection (e.g., detecting families, couples, friends or other groups of customers that are visiting the store as a group), and/or the like. The system may include a number of subsystems that provide higher-level analysis of the image data and/or provide other environmental information such as a real-time virtual cart system.

The real-time virtual cart system functions to model the items currently selected for purchase by a customer. The virtual cart system may enable automatic self-checkout or accelerated checkout. Product transactions could even be reduced to per-item transactions (purchases or returns based on the selection or de-selection of an item for purchase).

The CV monitoring system 120 may additionally generate and/or maintain one or more data models of the environment. The data models may be used by the environment imaging planning system 130 in coordinating the control and operation of the imaging devices of the system. The data models may include a product location map which includes models a data associations between product identifiers and locations in the environment. The locations may be based on the 2D floor location in an environment, the 3D location in the environment, an image location (e.g., where located in image data collected from the environment), and/or any suitable characterization of location. The data models may include a user location data model that tracks location of users. The data models may additionally include a modeling confidence map, which relates the CV modeling confidence of different regions and/or events to locations in the environment. The data models may additionally include an interaction history map that relates the occurrences of interactions to locations in environment.

The environment imaging planning system 130 functions to monitor observations from the CV monitoring system no and then to manage control of the set of dynamically controlled imaging devices. The environment imaging planning system 130 can be used to coordinate the collection of HV image data to more efficiently supplement a base layer of image data processed by the CV monitoring system no. The environment imaging planning system 130 preferably manages updating and maintaining of high fidelity imaging and monitoring of an environment. The environment imaging planning system 130 preferably takes input from CV monitoring system no in determining areas of product identification with low/lower confidence.

The environment imaging planning system 130 may track various conditions such as tracking changes in the environment. In the retail environment, this may include detecting when the shelving of products changes either because of a stocking event or because of user-caused changes to how products are arranged on the shelves. Detection of changes in the product location map may be used in detecting changes in the environment.

The environment imaging planning system 130 may additionally track user activity in the environment, preferably using the people tracking information of the CV monitoring system 110. The user activity can be used to coordinate when and how HV image data may be collected. The user location map may be used by the environment imaging planning system 130 for detecting various conditions related to user location.

As described above, the HV image data may be collected in coordination with low activity such as when collecting an image data for identifying products on shelves. The HV image data may additionally or alternatively be collected in coordination with monitored events. The environment imaging planning system 130 may direct control of the dynamic imaging devices so that useful HV image data can be collected before, during, or after some activity like a customer picking up or otherwise interacting with a product.

### 3. Method

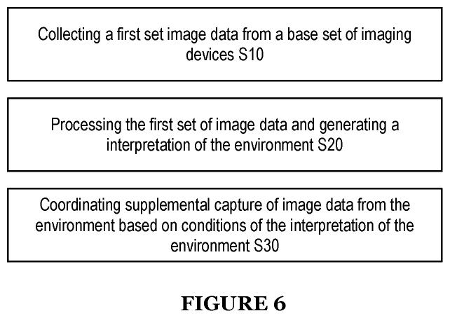

As shown in FIG. 6, a method for using a dynamically controlled camera for computer vision monitoring can include collecting a first set image data from a base set of imaging devices S10, processing the first set of image data and generating a interpretation of the environment S20, and coordinating supplemental capture of image data from the environment based on conditions of the interpretation of the environment S30.

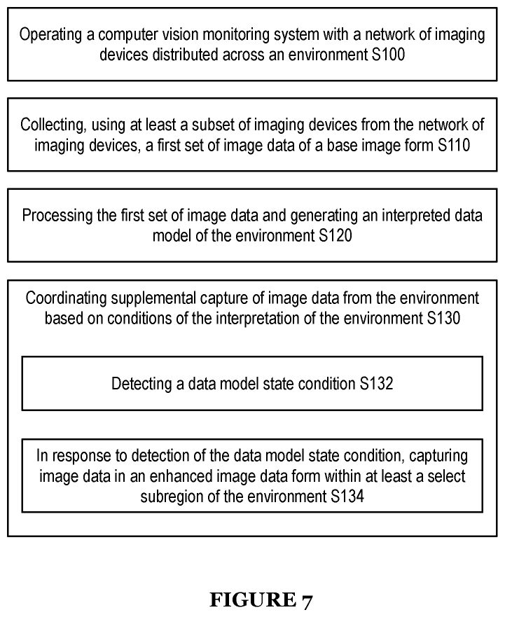

The method functions to use adaptive image collection techniques that are customized to the demands and challenges of operating a computer vision monitoring system with a network of imaging devices. As shown in FIG. 7, a variation of the method applied to the controlling of an imaging network may include: operating a computer vision monitoring system with a network of imaging devices distributed across an environment S100; collecting, using at least a subset of imaging devices from the network of imaging devices, a first set of image data of a base image form S110; processing the first set of image data and generating an interpreted data model of the environment S120; coordinating supplemental capture of image data from the environment based on conditions of the interpretation of the environment S130 which can include: detecting, through the data model, a data model state condition S132 and, in response to detection of the data model state condition, capturing image data in an enhanced image data form within at least a select subregion of the environment S134. Capturing the image data in the enhanced image data form can include individually controlling at least a first imaging device within the network of imaging devices and changing the settings of the first imaging device to target the select subregion thereby capturing a target set of supplemental image data of an enhanced image form.

The method may be particularly useful for a CV monitoring system being used in operating a digital interaction experience. For example, the CV monitoring system may be used in facilitating automated or semi-automated checkout experiences. The CV monitoring system may alternatively be used for other purposes such as being used as part of a system to support retail analytics and/or an operational monitoring solution.

In particular, the method can be used within a retail environment where a data model of the environment includes a product location map (e.g., a store planogram) that associates product identifiers with various stocking locations in the environment. Furthermore, the method may be particularly useful in enabling the detecting and analysis of user-item interactions such as user-item interactions relating to the shopping interactions of a customer with a stocked product. In some cases, the method may facilitate maintaining a reliably accurate and current product location map, which can be used in interpreting user-item interactions.

Accordingly, the method may be adapted to the retail monitoring use case by, for example, collecting, using at least a subset of imaging devices from the network of imaging devices, a first set of image data of a base image form S110 covering inventory stocking surface regions of an environment; processing the first set of image data and generating an interpreted data model of the environment S120, which includes maintaining a product location map and status of the image data used in keeping the product location map current; coordinating supplemental capture of image data from the environment based on conditions of the interpretation of the environment S130 which can include: detecting, through the data model, an data model state condition S132 indicating image data status in a subregion of the inventory stocking surface regions being in condition for updated analysis with enhanced image data and, in response to detection of the data model state condition, capturing image data in an enhanced image data form within at least the subregion of the environment S134. As discussed herein, various method variations may leverage other CV monitoring capabilities to alter the image capturing process to further enhance the CV monitoring objectives. This can enable unique capabilities within a CV monitoring system to perform significantly greater accuracy in monitoring with potentially reduced hardware operation costs and/or imaging devices.

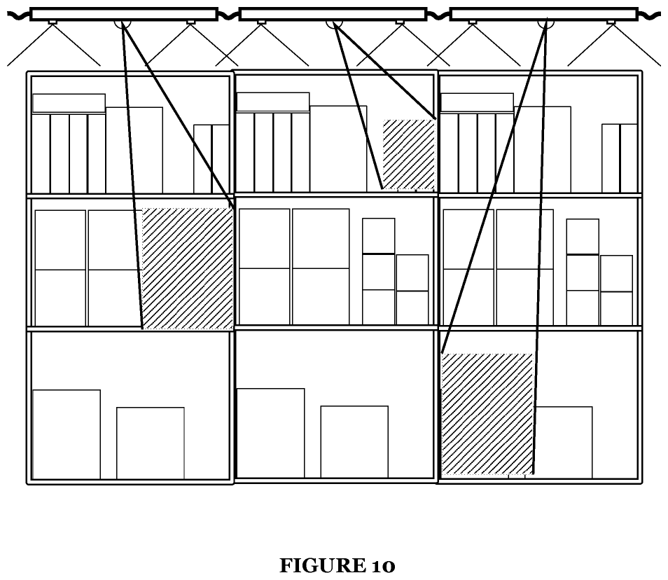

The method is preferably performed in a continuous fashion within a CV monitoring system such as the one described herein. Furthermore, the method is preferably implemented such that the method may be implemented in parallel fashion across an array of imaging devices. For example, within one CV monitoring system, a first dynamically controlled imaging device may be individually controlled and used to collect supplemental HV image data while a second dynamically controlled imaging device is used independently so as to collect supplemental HV image data to be used separate from the other HV image data. As shown in the schematic example of FIG. 10, different dynamic actuating imaging devices may collect enhanced image data of different targeted products independent of each other. However, in some variations, control of multiple dynamic imaging devices may be performed in cooperation. When applied to monitoring shopper activity in a retail environment, this may be used so a first dynamically controlled imaging device collects enhanced image data related to a first customer interacting with products, while a second dynamically controlled imaging device collects enhanced image data related to a second customer interacting with products in another region. The method may alternatively be used with any suitable type of imaging and/or monitoring system.

Block S100, which includes operating a computer vision monitoring system with a network of imaging devices distributed across an environment, functions to run a monitoring system that senses data from multiple points in an environment. The computer vision monitoring system can be one such as that described above. Operating the computer vision monitoring system can involve collecting of image data from the network of imaging devices. This will generally involve collecting image data of a base image form as well as (at least periodically) enhanced image data of an enhanced image form (e.g., high value image data). Accordingly, operating the computer vision monitoring system can include communicating with a plurality of imaging devices which may be used for collecting image data and/or directing control over one or more imaging devices (or devices coupled to the imaging devices like a mobile robot). Operating a computer vision monitoring system can involve at a computer-readable medium (e.g., non-transitory computer-readable medium) storing instructions that, when executed by one or more computer processors of a communication platform, cause a computing system associated with the computer vision monitoring system to performing one or more of the processes described herein.

Block S110, which includes collecting a first set of image data of a base image form, functions to collect video, pictures, or other imagery of an environment to be used as default set of image data for computer vision processing. In one variation, the image data of the base image form (i.e., base image data) can be collected from a base set of imaging devices, which may be dedicated to the collection of base image data. For example, in one implementation a first subset of imaging devices can be specifically configured for collecting image data of the base image form. The first subset of imaging devices may include a number of cheaper and lower resolution imaging devices. However, the first set of imaging devices may not be limited to such types of imaging devices. In another variation, the image data of the base image form can be collected from imaging devices that can selectively collect data used for base image data or enhanced image data.

The image data of the base image form will generally have image quality (by some metric) that is of lower quality than image data of an enhanced image form, for at least some objectives. In general, the base image form will have imaging resolution of the objects of interest with lower resolution when compared to an enhanced image form. As a note, the sensor or raw image resolution could, in some variations, be the same as the sensor or raw image resolution of image data. Additionally, the base image data may have several imaging advantages such as wider area coverage, faster framerate, more efficiently stored as a limited list of potential advantages.

The image resolution or quality as a function of the objects of interest will generally see the base image data having a lower resolution or quality in image data of a particular object compared to enhanced image data of the same object. For example, the pixel density for the base image data of a product on a shelf may be half the pixel density of the enhanced image data of the product. As the distance of objects from an imaging device will vary, the level of enhancement may not be uniform and can vary. However, there will generally be an improvement of image data in the enhanced image data over the base image data for objects of interest in the environment.

The image data is preferably captured over a region expected to contain objects of interest (e.g., inventory items and/or users) and interactions with such objects. Image data is preferably collected from across the environment from a set of multiple imaging devices. Preferably, collecting image data occurs from a variety of capture points. The set of capture points include overlapping and/or non-overlapping views of monitored regions in an environment. The base image data can preferably provide a substantially uniform continuous coverage of an environment, such that the image data can provide simultaneous image data across monitored region. Some holes or regions of non-coverage may exist within an environment.

Alternatively, the method may utilize a single imaging device, where the imaging device has sufficient view of the exercise station(s). The image data preferably substantially covers a continuous region. However, the method can accommodate for holes, gaps, or uninspected regions. In particular, the method may be robust for handling areas with an absence of image-based surveillance such as bathrooms, hallways, and the like.

The image data may be directly collected, and may be communicated to an appropriate processing system. The image data may be of a single format, but the image data may alternatively include a set of different image data formats. The image data can include high resolution video, low resolution video, photographs from distinct points in time, image data from a fixed point of view, image data from an actuating camera, visual spectrum image data, infrared image data, 3D depth sensing image data, parallax, lidar, radar, sonar, passive illumination, active illumination, and/or any suitable type of image data.

The method may be used with a variety of imaging systems, collecting image data may additionally include collecting image data from a set of imaging devices set in at least one of a set of configurations. The imaging device configurations can include: aerial capture configuration, shelf-directed capture configuration, movable configuration, and/or other types of imaging device configurations. Imaging devices mounted over-head are preferably in an aerial capture configuration and are preferably used as a main image data source. In some variations, particular sections of the store may have one or more dedicated imaging devices directed at a particular region or product so as to deliver content specifically for interactions in that region. In some variations, imaging devices may include worn imaging devices such as a smart eyewear imaging device. This alternative movable configuration can be similarly used to extract information of the individual wearing the imaging device or other observed in the collected image data.

Block S120, which includes processing the first set of image data and generating an interpreted data model of the environment, functions to convert the first set of image data to information about the environment. The interpretation of the environment may be implemented for identifying and/or classifying items in an environment (e.g., identifying products, characterizing how they are stored on shelves, etc.), detecting user-item interaction events (detect, record history of user actions and behavior), and/or collecting other information within the environment. Higher level interpretation of the environment may also be performed for facilitating modeling of particular activities such as tracking or detecting a selection of products by a customer shopping in a store (e.g., a virtual cart) so that a form of automatic or at least semi-automated checkout may be performed.

In some variations, the interpretation of the environment may be performed solely on the first set of image data from the base set of imaging data. In other instances, the interpretation may additionally use the supplementary captured image data. More preferably, processes S110, S120, and S130 are implemented in a continuous process such that supplemental captured image data of an enhanced image form can be used during the generation of an interpretation of the environment, thereby improving the interpretation of the environment. As will be described below, in some variations, the processing of the image data may by attempt usage of image data of an enhanced image form when available and default back to image data of the base image form when enhanced image data is unavailable or does not qualify for use with the particular image data analysis process.

Processing the first set of image data and generating an interpretation of the environment may include classifying objects from the image data, tracking object locations in the environment, and/or detecting interaction events. These processes may be used in other areas of CV processing in the method. With respect to monitoring inventory and user interactions with inventory, CV processing can include: classifying product items from the image data from the commerce region; tracking user location in the environment; and detecting user-item interaction events.

In such variations, generating an interpreted data model of the environment may include maintaining and/or generating: a product location map data model and/or a user location data model.

The product location map functions to relates product identity to locations in the environment. In some variations, the method is used to keep the product location map accurate and as current as possible with enhanced image data since last changes to the stocking of products. Status of the product location map (e.g., where low confidence product identification is present, where there are holes, etc.) and detected changes in product stocking may be used in determining subregions of the environment that could benefit from enhanced image data.

The user location data model functions to track the location of users. The tracking may be continuous where an individual is trapped through the environment. The tracking may alternatively be generalized to user presence so that it detects presence of users (but possibly not linking a location of a person from one moment to their location at a second moment). User location data model may in particular be used in triggering when enhanced image data can and/or should be collected.

As one variation, generating an interpreted data model of the environment can additionally or alternatively include maintaining and/or generating a modeling confidence map. A modeling confidence map may be a historical analysis of computer vision monitoring (or other forms predictions) as it relates to locations. A modeling confidence map may associate a score (e.g., a confidence score) to different locations. The locations may be locations in the image data or 2D or 3D location of the environment. In one particular application, the modeling confidence map may relate to a product location map so that regions of the product location map (e.g., regions of a product shelf) can be understood to present challenges for CV monitoring. The modeling confidence map may be used in determining the priority of where to capture enhanced image data. For example, when a condition initiates a situation where there is a limited amount of time to capture enhanced image data, the modeling confidence map can be queried and used to determine that supplemental image data may be most helpful for a particular region of the shelf (e.g., a section stocking small spice bottles) as compared to a region where there is historically high confidence in the image modeling (e.g., a section stocking large box items with clear differentiating labels for product identification).

Similarly and/or alternatively, an interpreted data model can include an interaction history map which functions to relate the number or probability of interactions to different locations in the environment. In particular, the interaction history map can be a data model relating interaction history to product storage locations. This can be used in combination with or as an alternative to the modeling confidence map when determining the priority of where to capture enhanced image data.

For example, when a condition initiates a situation where there is a limited amount of time to capture enhanced image data, the interaction history map can be queried and used to determine that there is a higher probability of an interaction happening in a first region over a second region and therefore collecting supplemental enhanced image data in the first region rather than the second region.

Other suitable data models may additionally or alternatively be maintained and used in informing when, where, and/or how supplemental enhanced image data can be collected. The data models can serve for dynamic querying, inspection, and analysis for various conditions. They may also be used to trigger different events when the state of the data model changes. The data models are preferably stored in a database system or systems. They can be stored as part of the CV monitoring system or be communicatively accessible through some interface.

The method may additionally include tracking a checkout list according to object classifications, user location, and the detected interaction events. This may be performed as part of automated checkout. However, this could also be used in tracking and detecting if and when products are purchased. Monitoring commerce activity preferably includes iteratively processing the image data and applying various image data analysis processes.

Classifying objects from the image data functions to perform object detection. Objects are detected and classified using computer vision or other forms of programmatic heuristics, artificial intelligence, machine learning, statistical modeling, and/or other suitable approaches. Object classification can include image segmentation and object identification as part of object classification. Resulting output of classifying objects of image data of a single image or video stream can be a label or probabilistic distribution of potential labels of objects, and a region/location property of that object. Classifying objects in a single image of the image data can yield multiple object classifications in various regions. For example, an image of a shelf of products with a shopper present can yield classifications for each visible product, the shelf, and the shopper.

Various techniques may be employed in object classification such as a “bag of features” approach, convolutional neural networks (CNN), statistical machine learning, or other suitable approaches. Neural networks or CNNS such as Fast regional-CNN (r-CNN), Faster R-CNN, Mask R-CNN, and/or other neural network variations and implementations can be executed as computer vision driven object classification processes.

Image feature extraction and classification is an additional or alternative approach, which may use processes like visual words, constellation of feature classification, and bag-of-words classification processes. These and other classification techniques can include use of scale-invariant feature transform (SIFT), speeded up robust features (SURF), various feature extraction techniques, cascade classifiers, Naive-Bayes, support vector machines, and/or other suitable techniques.

Additionally, multiple variations of algorithmic approaches can be implemented in accounting for particular classes of object classification. A hierarchical classification process can be used in iteratively refining classification and/or bounding the classification challenge for enhancing classification confidence and/or speed. In one variation, classifying objects can be limited or isolated to updating based on changes in image data. In one variation, classifying objects of image can be limited to subregions of the image data satisfying a change condition. For example, an image of a shelf of products with a shopper in the lower right quadrant of the image may only have object classification executed for a region within that lower right quadrant, which can alleviate the method from reclassifying products that are static in the image data.

In some variations, object classification can be actively confirmed or informed through another data input channel. For example, a calibration tool may be used for logging an object with a confirmed classification (e.g., a SKU identifier), location, and time.

Classifying objects preferably includes identifying a product identifier for visible products. The product identifier may be SKU or data record of a product, which may include various pricing information that can be used in adding the item as an invoiced item if selected.

Tracking objects in the environment functions to monitor the location of an object in establishing an object path. Tracking an object can include tracking the object within image data from a single image capture device but more preferably tracks the object across image data from multiple image capture devices. Tracking an object can additionally be used in identifying and associating objects across image capture devices.

Tracking objects in the environment can, in some variations, include tracking people (i.e., users) in the environment. Tracking users functions to maintain association of a user with collected payment mechanism and/or vehicle station. Tracking objects in the environment may additionally be used in tracking items as they move through the store and their association with a user, which can signal an intention to purchase.

Tracking an object can include applying CV-based object tracking techniques like optical flow, algorithmic target locking and target re-acquisition, data-driven inferences, heuristical processes, and/or other suitable object tracking approaches. In the case of person tracking a variety of person tracking techniques may be used. CV-based object tracking and algorithmic locking preferably operate on the image data to determine translation of an object. Data-driven inferences may associate objects with matching or similar data features when in near temporal and spatial proximity. “Near” temporal and spatial proximity can be characterized as being identified in a similar location around the same time such as two objects identified within one to five feet and one second. The temporal and spatial proximity condition could depend on various factors and may be adjusted for different environments and/or items. Objects in near temporal and spatial proximity can be objects observed in image data from a neighboring instance of image data (e.g., a previous video frame or previously capture image still) or from a window of neighboring instances. In one variation, a window of neighboring instances can be characterized by sample count such as the last N media instances (e.g., last 10 video or still frames). In another variation, a window of neighboring instances can be characterized by a time window such as media instances in the last second.

Detecting interaction events functions to identify and characterize the nature of changes with at least one object. Interaction events can be detectable changes observed in the image data. Preferably, interaction events can be used in applying compound object modeling and multi-state modeling. An interaction event can additionally include triggering updating a modeled data such as a checkout list of a user. Interaction events (their conclusion or beginning) could additionally trigger changes in collecting of image data as described below.

Detecting an interaction event preferably includes detecting a user-item interaction which can be CV-based detection and/or classification of an event observed in the image data involving interactions of a user with a monitored object. Monitored objects preferably include products for purchase and/or items for use. Detecting a user-item interaction may involve detecting a user pose with some relationship to an object. The user pose may be associated with a user-item interaction, despite only classifying the user pose by also: detecting proximity of the user to an object or region of objects; the image data being collected from a region where the pose is associated with the user-item interaction (e.g., in an aisle of a store); or other approaches.

Detecting user-item interactions may include: detecting a user selecting of a product and thereby adding the associated item to the checkout list and optionally detecting a user deselecting of (e.g., setting down) a product and thereby removing the associated item from the checkout list. Detecting user-item interactions for usage-based interactions may include detecting use or consumption of an item. Detecting usage may include actions such as detecting dispensing of a drink from a drink machine or making use of amenities such as a waiting room or watching media.

Furthermore, detecting user-item interactions may include detecting directed user attention, which can include estimating user pose and attention relative to a product and/or shelf-space location.

Detecting attention and initial poses of a user-item interaction, or other indicative visual signals may be used in preemptively anticipating a user-item interaction, which may be used in preparing for supplemental enhanced image collection.

Block S130, which includes coordinating supplemental capture of image data from the environment based on conditions of the interpretation of the environment, functions to manage the use of a dynamically controlled imaging device for the collection of image data in an enhanced image data form.

Coordinating supplemental capture of image data S130 can include detecting a data model state condition S132 and, in response to detection of the data model state condition, capturing image data in an enhanced image data form within at least a select subregion of the environment S134. As a result, enhanced image data can be selectively collected at appropriate moments and/or in situations where it can provide particular benefit to the analysis of the image data.

Block S132, which includes detecting a data model state condition, functions to determine one or more situations where supplemental enhanced image data could and should be collected. The data model state condition is preferably detected through analysis of the data model of S120. Detecting the data model state condition may further include identifying a subregion of the environment with image data that qualifies for enhanced resolution capture. In this way the location and/or time for supplemental image data can also be detected. Additionally, the method may additionally include determining the subset of imaging devices and their configuration for collection of the enhanced image data. For example, detecting the data model state condition can further trigger determining where in the environment would benefit, and which camera should collect the image data and how. For a movable camera this would include how the camera is positioned, zoomed, and operated (e.g., camera exposure settings) as well as any instructions relating to how it may move to raster across an area.

The data model state condition will generally be indicative of one or more different scenarios when supplemental image data collection would potentially be beneficial. The data model state conditions are preferably evaluated at a local level. Within an environment, there may be several regions that simultaneously have conditions that initiate supplemental image data collection locally for their specific region.

Various factors may be considered in evaluating a condition. In some variations, the method may perform supplemental image data for only one type of data model state condition. Alternatively, the method may detect a set of different data model state conditions are response appropriately for each.

As one potential factor into the data model state condition, the timing of the collection of enhanced image data can be based around detecting situations when enhanced image data has a time window for collection. Some variations use techniques and/or image capture devices that require some time to collect the enhanced image data. For example, a movable imaging device may have to raster over a region of shelves that need high resolution imaging. In some variations, detecting the data model state condition can include calculating a collection plan and evaluating if the supplemental image data can be collected. This may be particularly useful for image capture techniques that take time and/or alternatively divert resources away from normal operation.

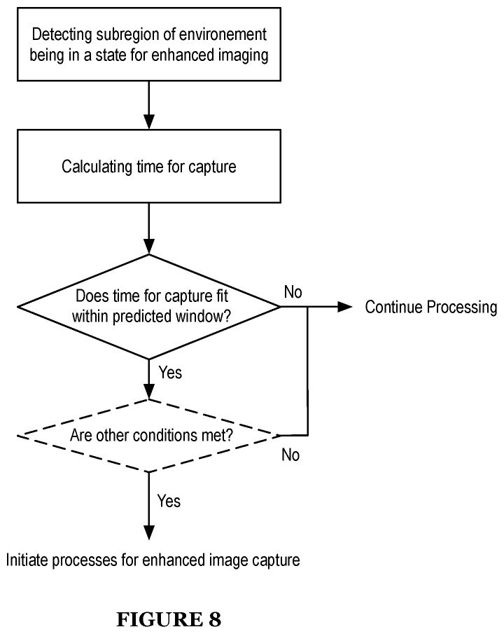

In a variation where collecting the supplemental image data includes deploying a mobile robotic device that collects supplemental image data, the time availability and the time to execute the capture can be integrated into the condition analysis. As shown in an example of FIG. 8, detecting the data model state condition can include detecting a first subregion of the environment in a state for updating with enhanced image data of the subregion, calculating time for capturing the enhanced image data of the subregion, evaluating if time of capture is permitted for current environment status as indicated in the data model, potentially evaluating other operational conditions, and if confirmed executing capture of the enhanced image data. Calculating the time for capturing the enhanced image data of the subregion may include detecting location of a mobile robot device and calculating sum of travel time from the current or planned location to the location for capture of the subregion and capture execution time. Evaluating if time of capture is permitted for the current environment status may evaluate if there are any users or other mobile objects that could disrupt the capture process (e.g., walking in front of a shelf to be imaged, or disrupting the travel path of a mobile robotic device).

As another potential factor into the data model state condition, the conditions of the localized environment may depend on the presence or state of different objects. As a limited list of examples of various scene conditions can include the presence or lack of presence of: occlusions of a product shelf, a user and the user's proximity to products, and the change or disruption of products on a shelf.

With respect to occlusions, in some variations, detecting the data model state condition can include detecting a lack of occlusions of an object or a subregion. In some situations, the method can assist in keeping a highly accurate and an updated view of background image data. In a retail environment this would include the products displayed in the store. Enhanced image data can be used in identifying the products with higher confidence. Additionally, detecting a lack of occlusions of the object or subregion can include detecting a time window with no occlusions. In some cases, this can be a prediction of when there would be no occlusions.

With respect to object presence, in some variations, detecting the data model state condition can include detecting the presence of one or more objects. In some situations, enhanced image data may be captured when a certain object or objects are present. As described more below, some conditions may depend on the presence of a user for example.

With respect to changed state of background image data, in some variations, detecting the data model state condition can include detecting a change in environment background image data. Background changes may be specifically used in detecting when the stocking of products on display in a store are changed. It could similarly or alternatively be used for detecting changes in visual displays (e.g., signs and promotional displays). If a new product is placed somewhere or moved, then this may be a prompt for collecting enhanced image data prior to some potential future event like a user picking up an item from that section.

Detecting a change in the environment background image data can involve comparing previous image data to current image data. Comparing image data of the same region at different times can involve doing a difference of the image data. This difference may be a normalized image difference to account for slight changes in image data (e.g., resulting from changing lighting conditions and the like).

In some cases, the change in background image data from the last collection of enhanced image data can be of particular interest. Accordingly, detecting the change in environment background may involve comparing the current base image data to previous enhanced image data for a region in the environment. Alternatively, changes in background image data can be performed between two periods of base image data. Detecting a change in the environment background image data may include establishing background image data. This may include performing a low pass filter of the image data to remove any foreground image elements. Other approaches may alternatively be used.

As another potential factor into the data model state condition, supplemental image data capture may be used to support the analysis of particular events based on how and where it would help. Conditions may be configured to trigger when certain situations are predicted, detected, and/or have just completed. Such conditions may consider various elements in indicating if collecting enhanced image data may be helpful.

As another potential factor, the data model state conditions may incorporate the analysis of the whole or portions of the environment such that supplemental image data can be prioritized to regions and situations where there may be overall improvements. In this way, detecting a data model state condition that factors in priority may include evaluating priority of different subregions of the environment and identifying subregions of higher priority, directing collection of supplemental image data to the subregions of higher priority first. Priority may be determined by prediction history (e.g., where are challenging areas for CV modeling) and/or interaction history (e.g., where do events happen more likely). Other factors could be product information such as which products are of higher value or at higher risk of theft.

The conditions may be preconfigured as a set of heuristics or logical rules. Alternatively, an algorithmic model (e.g., a machine learning or deep learning model) may be used in adaptively. For example, the historical data related to the CV monitoring of an environment may be categorized by when supplemental image data would have helped or not.

Block S134, which includes capturing image data in an enhanced image data form within at least a select subregion of the environment in response to detection of the data model state condition, functions to dynamically collect enhanced image data based on the monitored state of the environment.

Capturing image data in the enhanced image data form can include individually controlling at least a first imaging device within the network of imaging devices and changing the settings of the first imaging device to target the select subregion and capturing a target set of supplemental image data in an enhanced image form from the first imaging device. In some situations, multiple imaging devices may be controlled such that multiple views or forms of enhanced image data can be collected for one situation.

Controlling one or more imaging device(s) may be used for: capturing close up, high resolution image data of a target; capturing image data for reduced motion blurring of a target (e.g., a moving target); capturing a wider field of view across a designated target region; capturing image data from a useful point of view (e.g., an off-angle view free from obstructions); and/or other useful forms of supplemental image data.

In many cases, this involves collecting image data with a higher resolution of a target region than is collected from a base set of imaging devices. Higher resolution may be a higher resolution in terms of pixel density for the object(s) and/or region of interest. Accordingly, coordinating supplemental capture of image data may include individually controlling dynamic imaging devices and changing the settings of a dynamic imaging device to target a particular region of the environment and capturing a target set of supplemental image data. Changing the settings may include actuating the dynamic imaging device to be directed at the particular region, optically zooming the dynamic imaging device to capture the particular region, focusing on a particular element, and/or changing digital settings for increased resolution.

In one variation, the controlled imaging device is an active imaging device. An active imaging device may include an actuating imaging device and/or an optically zoomable imaging device. When the controlled imaging device is an active imaging device, controlling the active imaging device and changing the settings of the active imaging device to target the select subregion can include altering the field of view of the active imaging device relative to the select subregion. The imaging device may be moved and/or zoomed so that the field of view is narrowed or widened to achieve alternative imaging capability of the select subregion. This will generally involve capturing high resolution image focused on the select subregion.

When controlling an actuating imaging device, controlling the actuating imaging device and changing the settings of the actuating imaging device to target the select subregion can include orienting the actuating imaging device towards the select subregion. This can include orienting a field of view of the actuating imaging device which may include altering the direction/position of the imaging device (e.g., moving the camera). Depending on the capabilities of the actuating imaging device and/or the scenario orienting may include rotating, tilting, or otherwise adjusting rotational direction. Orienting the field of view may additionally include adjusting translational position if the imaging device includes or is connected to an actuation mechanism with linear degrees of freedom (or other forms of translational adjustments). In some cases, the active camera may be configured with a higher resolution image sensor or an optical lens system with fixed zoom for greater image resolution.

When controlling an optically zoomable imaging device, controlling the optically zoomable imaging device and changing the settings of the optically zoomable imaging device to target the select subregion can include adjusting zoom of the optically zoomable imaging device. The optically zoomable imaging device preferably includes a digitally controlled optical lens where the amount of zoom can be changed. The zoom may be adjusted to capture a field of view of interest. When the subregion of interest identified is localized to one product, then the zoom may, for example, be set so that the field of view is adjusted to so the bounding image box of the product fills at least a majority of the field of view (e.g., fills the camera view). In some situations, zoom may alternatively be adjusted to widen the field of view. For example, if an object is outside of a normal imaging view, the widening the field of view could expand the area that can be monitored.

In one variation, control of the active imaging device is used to provide a supplemental point of view. In such a variation, processing of the image data and/or analysis of the data model may be used in identifying a region of interest and adjusting an active imaging device for a field of view. In some cases, there may be multiple possible active cameras and so the method can involve selecting an active camera. Selecting the active camera may depend on other image data from other imaging devices with coverage. In some instances, complementary points of views may be desirable such that an active imaging device may be selected with field of view differing from an existing field of view (while also achieving some minimum level of imaging resolution for a region of interest). Accordingly, a variation of the method may include identifying a region for supplemental enhanced image data, determining a current imaging device sources of image data (e.g., base image data), and selecting an active imaging device from a set of potential active imaging devices based on relative position of the active imaging device and the current imaging device.

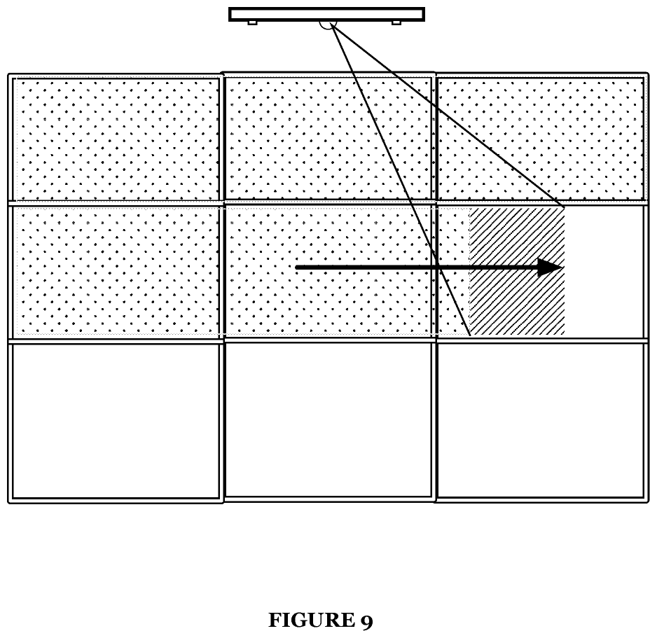

In another variation, control of the active imaging device is used to collect high resolution image data over a distributed region. In this variation, controlling the active imaging device may include rastering the field of view of the active imaging device across a region and collecting high resolution image data of different subregions as shown in FIG. 9. This can optionally include combining the high resolution image data of the different subregions. Alternatively, the different high resolution images may be kept separate and access appropriately by the CV monitoring system when requiring enhanced image data from a particular region.

This, for example, may be used for creating a HV image data of a shelf. When there are no occlusions and there have been changes to the stocking of the products, an active camera can collect image data while adjusting orientation and/or zoom to move the field of view across a product stocking region (e.g., a product shelf).

In one variation, the controlled imaging device is integrated into an automated moving system (e.g., a mobile robotic system). The automated moving system can include a ground-based robotic device that can move across the floor of the environment, an aerial robotic system (e.g., a drone), or other type of automated moving system. In one variation, a cable-based camera gantry system may be used where a camera can be moved up and down translated to different positions in the environment, and optionally rotated using cables or wires to suspend one or more imaging devices. The suspended camera system may move along a track system to move to different positions in the environment. Controlling an imaging device of an automated moving system may include deploying the automated moving system to a select subregion of interest. In general, deploying the automated moving system is used to collect enhanced image data of background. For example, identifying a region of shelving due to be updated with enhanced image data, may initiate directing the automated moving system to a position for enhanced image capture of the shelving region. This may additionally include rastering the imaging device over an extended region

In yet another variation, controlling the imaging device for capturing the supplemental image data in an enhanced image form may involve transitioning an imaging device from collecting image data in a base image mode to an enhanced image mode. This functions to transition an imaging device and/or the processing of its imaged data between a base operating mode and an enhanced mode. In some variations, an imaging device may have different sensing capabilities. Transitioning to an enhanced image mode can function to collect image data with a higher resolution or quality. In many cases, higher resolution capture modes may have lower framerates or other tradeoffs which is why they are only selectively used. In one example, an imaging device being operated in a video camera mode (that serves as the base image data) is changed to a still image capture mode so that a high resolution image or sequence of images can be captured.

Processing of the image data may additionally or alternatively be performed. In one example, transitioning an imaging device from collecting image data in a base image mode to an enhanced image mode includes performing super-resolution imaging of image data. Performing super-resolution imaging of the image data includes collecting multiple low resolution images of a scene and then combining the low resolution images, enhancing the resolution of the image data.

Capturing image data in the enhanced image data form may additionally include coordinating across multiple dynamic controlled cameras, which functions to dynamically select an appropriate dynamic imaging device to be used for particular objectives. As the number of a dynamically controlled imaging device may be limited, one camera may not be able to capture each piece of supplemental image data that could be of value. This may be true when the environment is particularly crowded. The potential capture of supplemental image data may be prioritized and shared across dynamic imaging devices. As is described below, such prioritization may be particularly useful for event-based collection of supplemental image data.

Coordinating supplemental capture of image data may be used in one or more of a variety of ways. In one aspect, the supplemental capture of image data may be used to increase the HV image data for substantially slow changing image data. This form of supplemental image data will generally not be associated with interpretation of a particular event but instead the CV analysis of the environment that changes more slowly. As another aspect, the supplemental capture of image data may be used to augment the image data used for analysis of event. This form of supplemental data will generally benefit from image data collected at the same time as the event or close to the same time as the event.

In the case of augmenting slow-changing image data, coordinating supplemental capture of image data includes collecting image data during detected periods free of obstructions. The supplemental capture of image data may be performed in response to detected change in image data of the environment. For example, detecting a change in the products shelved in a store may trigger eventual capture of supplemental close-up image data of the products at the appropriate time. The supplemental capture of image data may be performed when no users or obstructions are detected. This may be used so that close-up image data of a shelf of products can be collected during store hours when it is detected that no customers are in an aisle. This may be performed throughout an environment, but may alternatively be performed only on select areas. This variation of supplemental image data may make use of dynamic imaging devices to periodically as the occasion arises collect high resolution image data of products and/or items stored throughout an environment. In this way, the inability of a product to be identified with a base imaging device can be augmented because the product identity can be determined from the high resolution image data collected previously.

In the case of augmenting detected or predicted events with supplemental image data, coordinating supplemental capture of image data may include controlling and capturing supplemental image data in coordination with an event. The event may be actual detected or monitored event. The event may alternatively be a potential or predicted event. For example, supplemental image data may be preemptively collected in anticipation of a customer picking up a product they are inspecting. If the event does not happen the supplemental image data may be discarded or used in any suitable manner.

In general, the events are based on or around user activity. Herein, the event based supplemental image data are described as if for user-associated events, but the method may be modified for events based around other entities such as vehicles, automated systems, animals, and the like.

Controlling and capturing supplemental image data in coordination with an event can include monitoring a set of users. Monitoring a set of users preferably includes tracking location of the users, detecting and/or predicting actions of the users, detecting and/or predicting user-item interactions, and/or monitoring other aspects of the users. Monitoring of the users can preferably be done so as to determine when an event may occur, is occurring, and/or has occurred.

In a pre-emptive variation, controlling and capturing supplemental image data in coordination with an event may include preemptively capturing supplemental image data. As one exemplary scenario, preemptively capturing supplemental image data can be used to capture the state of a region to which an interaction may is about to happen. For example, in anticipation of a user picking up a product from a particular shelf, high resolution images can be collected of that region of the shelf where interaction may be likely and/or where supplemental image data will be the most useful.

Preemptively capturing supplemental image data can involve detecting a data model state condition indicative of a potential event, and proactively initiating capturing of image data in an enhanced image form. This may be specifically applied to preemptively capturing supplemental image data for user-item interactions as such, detecting a data model state condition indicative of a potential user-item event can include detecting a user approaching a region of potential user-item interaction, and/or detecting a user performing an action potentially preceding a user-item interaction.

A variation detecting a user's approach may include tracking a location of a user-object in the environment; detecting the location of the user-object approaching a region of the environment; and identifying a select subregion within the select region of the environment for enhanced imaging, and capturing a target set of supplemental image data of an enhanced image form in the select subregion. When applied in a retail environment, this may involve detecting a person approaching a region of product shelving (e.g., by walking down an aisle), this triggers imaging devices to initiate collection of enhanced image data. Preemptively reacting to user paths can function to start enhanced image data collection in subregions where it may most likely benefit the CV modeling of potential user-item interactions. This can be used to move cameras into position for where likely and/or challenging to model interactions may occur. This may alternatively be used to refresh HV image data in regions where it may be helpful. More specifically, preemptive responses to user motion can include: rastering an active imaging device across a subregion of product shelving with low confidence modeling (e.g., low confidence in the product identification within the product location map); orienting an active camera to a subregion of the product shelving where CV classification of the user-item interactions and/or product identification have a historical trend of lower confidence (e.g., as indicated in a predictive history map); transitioning imaging devices from a base imaging mode to an enhanced imaging mode to capture high resolution image data of product shelving prior to any potential user interaction (and then potentially transitioning back to a base imaging mode for interaction monitoring). As discussed below, selection of the subregion may be prioritized on a number of factors including current state of CV modeling in the region.

In a simultaneous event variation, controlling and capturing supplemental image data in coordination with an event may include capturing supplemental image data simultaneous with the event. The supplemental image data may be of select targeted aspect associated with the event. These targets may be based on the user, one or more items, the environment, and/or other subjects.

Detecting the data model state condition can include detecting a user object performing a user-item interaction and in response to the user-item interaction, the method initiates capturing image data in the enhanced image data form. This may include directing an active imaging device towards the user-item interaction. This may also more specifically include directing an active imaging device towards a region of interest of a user-item interaction. For example, it may include directing an imaging device to the product detected to be the subject of a user's visual attention, to the user's hand location (as they reach for an item) and/or towards a cart or basket of the user's an anticipation of seeing an item moved into the cart or basket at the conclusion of the interaction.

In a post-event variation, controlling and capturing supplemental image data in coordination with an event may include capturing supplemental image data after the event. Accordingly, in this variation, detecting the data model state condition can include detecting completion of a user-object performing a user-item interaction in the subregion of the environment and subsequently performing enhanced image capture on some object associated with the user-item interaction such as the user or the item location of the user-item interactions. This may be used to collect image data as to the state of the user, items, or the environment after the event.

In one preferred implementation, this may be used to collect high resolution image data of a shelf after some user-product interaction occurred. It may be used to detect that a product was removed from the shelf. In such a variation, detecting the data model state condition can include detecting completion of a user-object performing a user-item interaction in a subregion of the environment, detecting the subregion to be free of occlusions (of the image background), and initiating collecting of enhanced image data at the subregion. Detecting the subregion to be free of occlusions functions to ensure that the user has moved away such that updated data of the shelf can be collected. Some variations may additionally include localizing the subregion of the environment to where the likely location of the item that was the subject of the user-item interaction, which could be the location of one product item or a number of products (e.g., if there is uncertainty of exactly where or if a user interacted with a product).

Coordinating supplemental capture of image data may include prioritizing image capture options by the set of dynamic imaging devices. Events (actual and predicted) and/or their processing to convert to an interpretation of the environment can be used to prioritize how supplemental image data is collected. This may facilitate distributing collecting of supplemental image data tasks across the set of dynamic imaging devices.

In one variation, prioritizing image capture options may include prioritizing based on user proximity to products with lower confidence CV monitoring (either in identifying and/or event detection). For example, a user interacting with products that are small with difficult to detect packaging differences may be prioritized for supplemental image data collection over a user nearby picking up a product identified with high confidence. A modeling confidence map, which can be maintained as part of the data model, may indicate which products have lower CV identification confidence and/or which regions of the product shelving have lower (or higher) confidence in CV analysis of user-item interactions. Regions with historically lower confidence CV analysis can be prioritized. In this way, for example, a region of a retail store where it's challenging to view interactions because of the angle of camera may have supplemental image data collected automatically to help resolve. The method may additionally learn when supplemental image data does not aid in certain situations such that supplemental image data can be collected where it may be better utilized.

In one variation, prioritizing image capture options may include prioritizing based on expected view-point coverage of an event or potential event. This may incorporate factoring in if and how other imaging devices are collecting data. For example, if a base imaging device would be occluded from viewing important activity (e.g., a user grabbing a product from a shelf) because of the current conditions (e.g., orientation of a shopper relative to the camera and the shelf), then a dynamic camera with an off-angle view may provide HV image data that would be prioritized over other potential HV image data.

Additionally, prioritizing may direct if and when pre-emptive, simultaneous, and/or post-event image data is collected. In this way, coordinating may additionally facilitate scheduling and planning collection of supplemental image data. Different supplemental imaging tasks may have some amount of time that is required. For example, an actuated camera requires time to move to a certain position and capture image data. Timing can be modeled and factored into coordinating supplemental image data collection.

Relatedly, coordinating supplemental capture of image data can include coordinating multiple dynamic controlled cameras. They may capture image data from different points of view. In one variation, they are targeted and positioned to focus on the same target. In another variation, different dynamic controlled cameras can be controlled and targeted and positioned to focus on different targets associated with an event. The controlled cameras may be targeted at a variety of targets such as tracking the hand of a user, a region of shelf space, a shopping cart, and/or other regions.

The method is preferably used to create a collection of image data that can be used to improve the visual analysis of an environment. In some variations, the processing of image data can benefit from utilizing high resolution image data of an image background before and/or after an event. In the case of monitoring retail activity, processing the image data may involve analyzing the background image data of product shelving prior to a user interaction and analyzing the background image data of the product shelving after the user interaction. This can enable a difference of the product shelving before and after to show how products changed after the user interaction. With the dynamic and responsive collection of enhanced image data, the method can enable isolating enhanced image data of background image data from before and after a user interaction to a single user. When such enhanced image data exists, it may be used for analyzing the user interaction. In some cases, the method may default back to most recent background image data if enhanced image data from before or after is not the strongest signal for the state of the background image data. For example, multiple people may have potentially interacted with a region between when the enhanced image data was collected and the event.

### 4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., a non-transitory computer-readable medium) storing instructions that, when executed by the one or more computer processors, cause a computing platform to perform operations comprising those of the system or method described herein such as: collecting a first set image data from a base set of imaging devices S10, processing the first set of image data and generating a interpretation of the environment S20, and coordinating supplemental capture of image data from the environment based on conditions of the interpretation of the environment S30 and/or method process variations described herein.

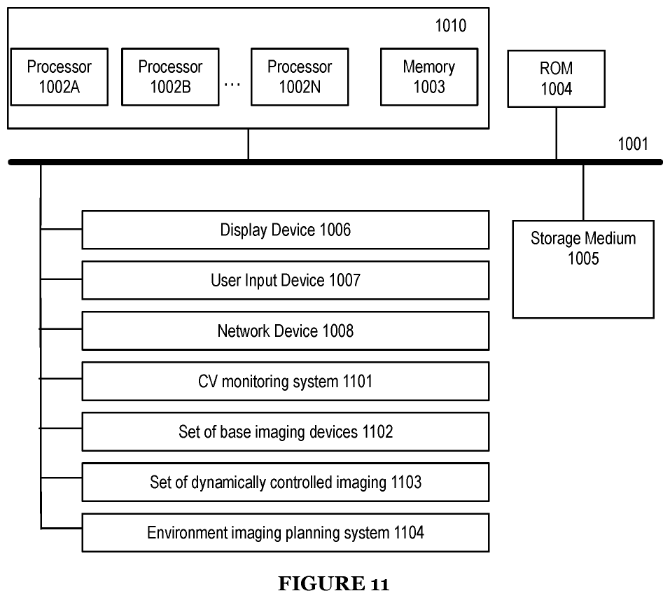

FIG. 11 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting a CV monitoring system 1101, a set of base imaging devices 1102, a set of dynamically controlled imaging 1103, environment imaging planning system 1104, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method for controlling an imaging network comprising:
operating a computer vision monitoring system with a network of imaging devices distributed across an environment;
collecting, using at least a subset of imaging devices from the network of imaging devices, a first set of image data of a base image form;
processing the first set of image data and generating an interpreted data model of the environment;
detecting, through the data model, a data model state condition; and
in response to detection of the data model state condition, capturing image data in an enhanced image data form within at least a select subregion of the environment, which comprises individually controlling at least a first imaging device within the network of imaging devices and changing the settings of the first imaging device to target the select subregion and capturing a target set of supplemental image data of an enhanced image form in the select subregion.

2. The method of claim 1, wherein detecting the data model state condition comprises detecting a change in environment background image data.

3. The method of claim 1, further comprising tracking, through processing of the image data, a location of a user-object in the environment; detecting the location of the user-object approaching a first region of the environment; and identifying the select subregion within the first region of the environment.

4. The method of claim 1, wherein detecting the data model state condition comprises detecting a user-object performing a user-item interaction in the subregion of the environment.

5. The method of claim 1, wherein detecting the data model state condition can include detecting completion of a user-object performing a user-item interaction in a subregion of the environment and detecting the subregion to be free of occlusions.

6. The method of claim 1, wherein the first imaging device is an active imaging device, wherein controlling the first imaging device within the network of imaging devices and changing the settings of the first imaging device to target the select subregion comprises altering the field of view of the active imaging device relative to the select subregion.

7. The method of claim 6 wherein the first imaging device is an actuating imaging device; and wherein controlling the first imaging device within the network of imaging devices and changing the settings of the first imaging device to target the select subregion comprises actuating the actuating imaging device towards the select subregion.

8. The method of claim 7, wherein the first imaging device is additionally optically zoomable imaging device; and wherein controlling the first imaging device within the network of imaging devices and changing the settings of the first imaging device to target the select subregion comprises adjusting the zoom of the optically zoomable imaging device.

9. The method of claim 6, wherein the first imaging device is part of an automated moving system; and wherein controlling the first imaging device within the network of imaging devices and changing the settings of the first imaging device to target the select subregion comprises deploying the mobile robotic vehicle to the select subregion.

10. The method of claim 1, wherein controlling the first imaging device within the network of imaging devices and changing the settings of the first imaging device to target the select subregion comprises transitioning the first imaging device from collecting image data in the base image mode to an enhanced image mode.

11. The method of claim 1, wherein transitioning the first imaging device from collecting image data in the base image mode to the enhanced image mode comprises performing super-resolution imaging of image data when in the enhanced image mode

12. A non-transitory computer-readable medium storing instructions that, when executed by one or more computer processors of a communication platform, cause the communication platform to perform the operations:
operating a computer vision monitoring system with a network of imaging devices distributed across an environment;
collecting, using at least a subset of imaging devices from the network of imaging devices, a first set of image data of a base image form;
processing the first set of image data and generating an interpreted data model of the environment;
detecting, through the data model, a data model state condition; and
in response to detection of the data model state condition, capturing image data in an enhanced image data form within at least a select subregion of the environment, which comprises individually controlling at least a first imaging device within the network of imaging devices and changing the settings of the first imaging device to target the select subregion and capturing a target set of supplemental image data of an enhanced image form in the select subregion.

13. The non-transitory computer-readable medium of claim 12, wherein detecting the data model state condition comprises detecting a change in environment background image data.

14. The non-transitory computer-readable medium of claim 12, further comprising tracking, through processing of the image data, a location of a user-object in the environment; detecting the location of the user-object approaching a first region of the environment; and identifying the select subregion within the first region of the environment.

15. The non-transitory computer-readable medium of claim 12, wherein the first imaging device is an active imaging device, wherein controlling the first imaging device within the network of imaging devices and changing the settings of the first imaging device to target the select subregion comprises altering the field of view of the active imaging device relative to the select subregion.

16. A system comprising of:
one or more computer-readable mediums storing instructions that, when executed by the one or more computer processors, cause a computing platform to perform operations comprising:
operating a computer vision monitoring system with a network of imaging devices distributed across an environment;
collecting, using at least a subset of imaging devices from the network of imaging devices, a first set of image data of a base image form;
processing the first set of image data and generating an interpreted data model of the environment;
detecting, through the data model, a data model state condition; and
in response to detection of the data model state condition, capturing image data in an enhanced image data form within at least a select subregion of the environment, which comprises individually controlling at least a first imaging device within the network of imaging devices and changing the settings of the first imaging device to target the select subregion and capturing a target set of supplemental image data of an enhanced image form in the select subregion.

17. The system of claim 16, wherein detecting the data model state condition comprises detecting a change in environment background image data.

18. The system of claim 16, further comprising tracking, through processing of the image data, a location of a user-object in the environment; detecting the location of the user-object approaching a first region of the environment; and identifying the select subregion within the first region of the environment.

19. The system of claim 16, wherein the first imaging device is an active imaging device, wherein controlling the first imaging device within the network of imaging devices and changing the settings of the first imaging device to target the select subregion comprises altering the field of view of the active imaging device relative to the select subregion.

20. The system of claim 16, wherein controlling the first imaging device within the network of imaging devices and changing the settings of the first imaging device to target the select subregion comprises transitioning the first imaging device from collecting image data in the base image mode to an enhanced image mode.
